(19) United States
(12) Patent Application Publication
(10) Pub. No.: US 2017/0060231 A1
(43) Pub. Date: Mar. 2, 2017

(54) FUNCTION CONTROL METHOD AND ELECTRONIC DEVICE PROCESSING THEREFOR

(71) Applicant: Samsung Electronics Co., Ltd, Gyeonggi-do (KR)

(72) Inventor: Kyung-Hwa Kim, Seoul (KR)

(21) Appl. No.: 15/256,458

(22) Filed: Sep. 2, 2016

(30) Foreign Application Priority Data
Sep. 2, 2015 (KR) 10-2015-0124409

(51) Int. Cl. G06F 3/01; G06F 3/16; G06T 1/00

(52) U.S. Cl. CPC G06F 3/011; G06F 3/015; G06T 1/0007; G06F 3/16; G06F 2203/011; G06T 2207/30201

(57) ABSTRACT

Disclosed are a function control method and an electronic device processing the method. An electronic device according to various embodiments may include a memory and a processor electronically connected to the memory. According to an embodiment, the processor may perform a control such that at least one function for the electronic device is performed, an emotion of a user for the performed function is determined, and a scheme for controlling the performed function according to the emotion of the user is output.

### CROSS-REFERENCE TO RELATED APPLICATION(S) AND CLAIM OF PRIORITY

The present application is related to and claims the priority under 35 U.S.C. §119(a) to Korean Application Serial No. 10-2015-0124409, which was filed in the Korean Intellectual Property Office on Sep. 2, 2015, the entire content of which is hereby incorporated by reference.

### TECHNICAL FIELD

Various embodiments of the present disclosure relate to an electronic device, for example, a device for controlling a function of an electronic device by detecting an emotion of a user and a method thereof.

### BACKGROUND

An electronic device may support various functions to provide various services to a user. In general, an electronic device may detect a control command generated by a user and perform a function corresponding to the control command. For example, an electronic device may detect a control command based on a key input, a voice input, a gesture input, etc.

### SUMMARY

An electronic device may perform a function corresponding to a user's input. For example, an electronic device may perform a function desired by the user in response to an input. The electronic device should accurately recognize the user's input in order to perform an operation desired by the user. However, the electronic device may have difficulty in accurately recognizing an input of a voice type. Accordingly, the user should generate an additional input until the desired operation is performed when the desired operation is not performed in response to the input.

An electronic device and method according to various embodiments of the present disclosure may determine an emotion of a user after performing an operation corresponding to an input of the user.

An electronic device and method according to various embodiments of the present disclosure may control an operation of the electronic device based on an emotion of a user.

An electronic device and method according to various embodiments of the present disclosure may provide feedback information based on the emotion of the user for the performed operation.

An electronic device according to various embodiments may include a memory and a processor electrically connected to the memory. For an embodiment, the processor may perform a control such that at least one function for the electronic device is performed, an emotion of a user for the performed function is determined, and a scheme for controlling the performed function according to the emotion of the user is output.

An operation method of an electronic device according to various embodiments may include operations of performing at least one function for the electronic device, determining an emotion of a user for the performed function, and outputting a scheme for controlling the performed function according to the emotion of the user.

A computer-readable recording medium according to various embodiments may store a program for performing operations of performing at least one function for the electronic device, determining an emotion of a user for the performed function, and outputting a scheme for controlling the performed function according to the emotion of the user.

Before undertaking the DETAILED DESCRIPTION below, it may be advantageous to set forth definitions of certain words and phrases used throughout this patent document: the terms “include” and “comprise,” as well as derivatives thereof, mean inclusion without limitation; the term “or,” is inclusive, meaning and/or; the phrases “associated with” and “associated therewith,” as well as derivatives thereof, may mean to include, be included within, interconnect with, contain, be contained within, connect to or with, couple to or with, be communicable with, cooperate with, interleave, juxtapose, be proximate to, be bound to or with, have, have a property of, or the like; and the term “controller” means any device, system or part thereof that controls at least one operation, such a device may be implemented in hardware, firmware or software, or some combination of at least two of the same. It should be noted that the functionality associated with any particular controller may be centralized or distributed, whether locally or remotely. Definitions for certain words and phrases are provided throughout this patent document, those of ordinary skill in the art should understand that in many, if not most instances, such definitions apply to prior, as well as future uses of such defined words and phrases.

### BRIEF DESCRIPTION OF THE DRAWINGS

For a more complete understanding of the present disclosure and its advantages, reference is now made to the following description taken in conjunction with the accompanying drawings, in which like reference numerals represent like parts.

FIG. 1 is a diagram illustrating an electronic device in a network environment according to various embodiments of the present disclosure;

FIG. 2 is a block diagram of an electronic device according to various embodiments of the present disclosure;

FIG. 3 is a block diagram of a program module according to various embodiments of the present disclosure;

FIG. 4 is a block diagram illustrating an electronic device according to various embodiments of the present disclosure;

FIG. 5 is a diagram illustrating a feedback generating operation of an electronic device according to various embodiments of the present disclosure;

FIG. 6 is a flow diagram illustrating a performance procedure of an application processing method of an electronic device according to various embodiments of the present disclosure;

FIG. 7 is a flow diagram illustrating a performance procedure of a feedback information output method of an electronic device according to various embodiments of the present disclosure;

FIG. 8 is a flow diagram illustrating another performance procedure of a feedback information output method of an electronic device according to various embodiments of the present disclosure;

FIG. 9 is a flow diagram illustrating a performance procedure of a search function providing method of an electronic device according to various embodiments of the present disclosure;

FIG. 10 is a diagram illustrating a screen configuration of an electronic device that provides a search function according to various embodiments of the present disclosure;

FIG. 11 is a flow diagram illustrating a performance procedure of an event processing method of an electronic device according to various embodiments of the present disclosure;

FIG. 12 is a diagram illustrating a screen configuration of an electronic device that processes an event according to various embodiments of the present disclosure;

FIG. 13 is a flow diagram illustrating a performance procedure of a schedule management method of an electronic device according to various embodiments of the present disclosure; and

FIG. 14 is a diagram illustrating a screen configuration of an electronic device that provides a schedule management function according to various embodiments of the present disclosure.

### DETAILED DESCRIPTION

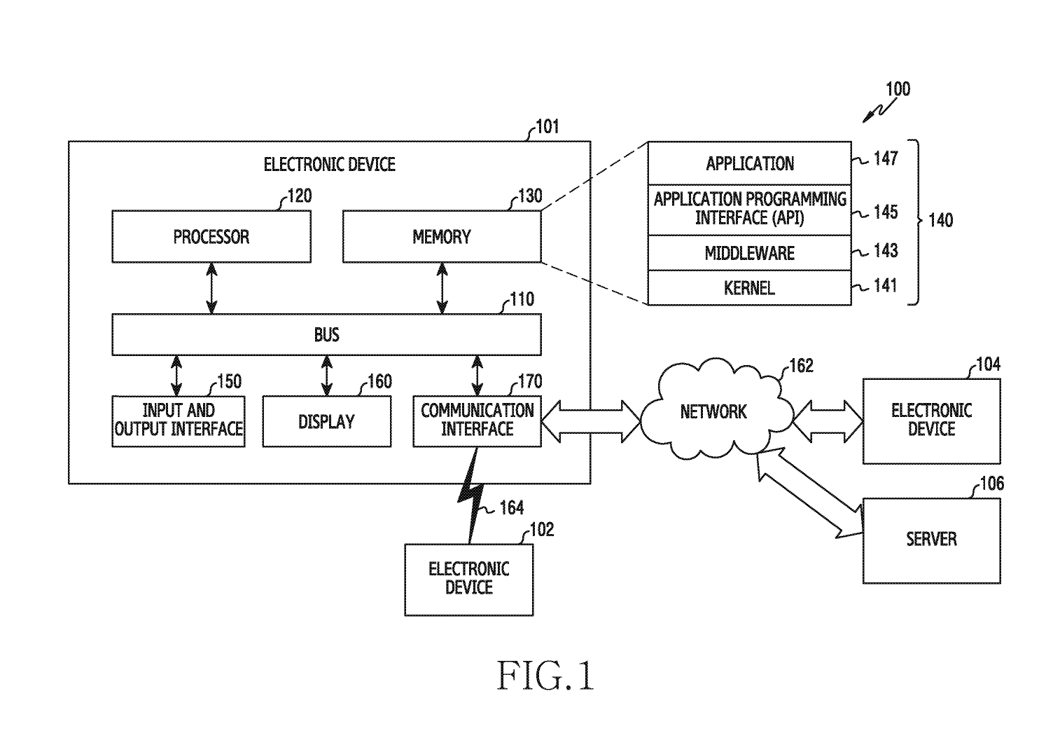

FIGS. 1 through 14, discussed below, and the various embodiments used to describe the principles of the present disclosure in this patent document are by way of illustration only and should not be construed in any way to limit the scope of the disclosure. Those skilled in the art will understand that the principles of the present disclosure may be implemented in any suitably arranged electronic device.

Hereinafter, various embodiments of the present disclosure will be described with reference to the accompanying drawings. In the following description, specific details such as detailed configuration and components are merely provided to assist the overall understanding of these embodiments of the present disclosure. Therefore, it should be apparent to those skilled in the art that various changes and modifications of the embodiments described herein can be made without departing from the scope and spirit of the present disclosure. In addition, descriptions of well-known functions and constructions are omitted for clarity and conciseness.

The present disclosure may have various embodiments, and modifications and changes may be made therein. Therefore, the present disclosure will be described in detail with reference to particular embodiments shown in the accompanying drawings. However, it should be understood that the present disclosure is not limited to the particular embodiments, but includes all modifications/changes, equivalents, and/or alternatives falling within the spirit and the scope of the present disclosure. In describing the drawings, similar reference numerals may be used to designate similar elements.

The terms “have”, “may have”, “include”, or “may include” used in the various embodiments of the present disclosure indicate the presence of disclosed corresponding functions, operations, elements, and the like, and do not limit additional one or more functions, operations, elements, and the like. In addition, it should be understood that the terms “include” or “have” used in the various embodiments of the present disclosure are to indicate the presence of features, numbers, steps, operations, elements, parts, or a combination thereof described in the specifications, and do not preclude the presence or addition of one or more other features, numbers, steps, operations, elements, parts, or a combination thereof.

The terms “A or B”, “at least one of A or/and B” or “one or more of A or/and B” used in the various embodiments of the present disclosure include any and all combinations of words enumerated with it. For example, “A or B”, “at least one of A and B” or “at least one of A or B” means (1) including at least one A, (2) including at least one B, or (3) including both at least one A and at least one B.

Although the term such as “first” and “second” used in various embodiments of the present disclosure may modify various elements of various embodiments, these terms do not limit the corresponding elements. For example, these terms do not limit an order and/or importance of the corresponding elements. These terms may be used for the purpose of distinguishing one element from another element. For example, a first user device and a second user device all indicate user devices and may indicate different user devices. For example, a first element may be named a second element without departing from the scope of right of various embodiments of the present disclosure, and similarly, a second element may be named a first element.

It will be understood that when an element (e.g., first element) is “connected to” or “(operatively or communicatively) coupled with/to” to another element (e.g., second element), the element may be directly connected or coupled to another element, and there may be an intervening element (e.g., third element) between the element and another element. To the contrary, it will be understood that when an element (e.g., first element) is “directly connected” or “directly coupled” to another element (e.g., second element), there is no intervening element (e.g., third element) between the element and another element.

The expression “configured to (or set to)” used in various embodiments of the present disclosure may be replaced with “suitable for”, “having the capacity to”, “designed to”, “adapted to”, “made to”, or “capable of” according to a situation. The term “configured to (set to)” does not necessarily mean “specifically designed to” in a hardware level. Instead, the expression “apparatus configured to . . . ” may mean that the apparatus is “capable of . . . ” along with other devices or parts in a certain situation. For example, “a processor configured to (set to) perform A, B, and C” may be a dedicated processor, e.g., an embedded processor, for performing a corresponding operation, or a generic-purpose processor, e.g., a Central Processing Unit (CPU) or an application processor (AP), capable of performing a corresponding operation by executing one or more software programs stored in a memory device.

The terms as used herein are used merely to describe certain embodiments and are not intended to limit the present disclosure. As used herein, singular forms may include plural forms as well unless the context explicitly indicates otherwise. Further, all the terms used herein, including technical and scientific terms, should be interpreted to have the same meanings as commonly understood by those skilled in the art to which the present disclosure pertains, and should not be interpreted to have ideal or excessively formal meanings unless explicitly defined in various embodiments of the present disclosure.

An electronic device according to various embodiments of the present disclosure may be a device. For example, the electronic device according to various embodiments of the present disclosure may include at least one of: a smart phone; a tablet personal computer (PC); a mobile phone; a video phone; an e-book reader; a desktop PC; a laptop PC; a netbook computer; a workstation, a server, a personal digital assistant (PDA); a portable multimedia player (PMP); an MP3 player; a mobile medical device; a camera; or a wearable device (e.g., a head-mount-device (HIVID), an electronic glasses, an electronic clothing, an electronic bracelet, an electronic necklace, an electronic appcessory, an electronic tattoo, a smart mirror, or a smart watch).

In other embodiments, an electronic device may be a smart home appliance. For example, of such appliances may include at least one of: a television (TV); a digital video disk (DVD) player; an audio component; a refrigerator; an air conditioner; a vacuum cleaner; an oven; a microwave oven; a washing machine; an air cleaner; a set-top box; a home automation control panel; a security control panel; a TV box (e.g., Samsung HomeSync®, Apple TV®, or Google) TV®; a game console (e.g., Xbox®, PlayStation®) an electronic dictionary; an electronic key; a camcorder; or an electronic frame.

In other embodiments, an electronic device may include at least one of: a medical equipment (e.g., a mobile medical device (e.g., a blood glucose monitoring device, a heart rate monitor, a blood pressure monitoring device or a temperature meter), a magnetic resonance angiography (MRA) machine, a magnetic resonance imaging (MM) machine, a computed tomography (CT) scanner, or an ultrasound machine); a navigation device; a global positioning system (GPS) receiver; an event data recorder (EDR); a flight data recorder (FDR); an in-vehicle infotainment device; an electronic equipment for a ship (e.g., ship navigation equipment and/or a gyrocompass); an avionics equipment; a security equipment; a head unit for vehicle; an industrial or home robot; an automatic teller's machine (ATM) of a financial institution, point of sale (POS) device at a retail store, or an internet of things device (e.g., a Lightbulb, various sensors, an electronic meter, a gas meter, a sprinkler, a fire alarm, a thermostat, a streetlamp, a toaster, a sporting equipment, a hot-water tank, a heater, or a boiler and the like)

In certain embodiments, an electronic device may include at least one of: a piece of furniture or a building/structure; an electronic board; an electronic signature receiving device; a projector; and various measuring instruments (e.g., a water meter, an electricity meter, a gas meter, or a wave meter).

An electronic device according to various embodiments of the present disclosure may also include a combination of one or more of the above-mentioned devices. Further, it will be apparent to those skilled in the art that an electronic device according to various embodiments of the present disclosure is not limited to the above-mentioned devices.

FIG. 1 is a view illustrating a network environment 100 including an electronic device 101 according to various embodiments. Referring to FIG. 1, the electronic device 101 may include a bus 110, a processor 120, a memory 130, an input/output (I/O) interface 150, a display 160, and a communication interface 170.

The bus 110 may be a circuit for connecting the above-described elements (e.g., the processor 120, the memory 130, the I/O interface 150, the display 160 or the communication interface 170, etc.) with each other, and transferring communication (e.g., a control message) between the above-described elements.

The processor 120 may include a central processing unit (CPU), a communication processor (CP), a graphic processing unit (GPU).

The processor 120 may receive, for example, an instruction from the above-described other elements (e.g., the memory 130, the I/O interface 150, the display 160, or the communication interface 170, etc.) via the bus 110, decipher the received instruction, and execute an operation or a data process corresponding to the deciphered instruction.

The memory 130 may include any suitable type of volatile or non-volatile memory. The memory 130 may store an instruction or data received from the processor 120 or other elements (e.g., the I/O interface 150, the display 160, or the communication interface 170, etc.), or generated by the processor 120 or other elements. The memory 130 may include, for example, programming modules 140 such as a kernel 141, a middleware 143, an application programming interface (API) 145, or an application 147. The each of the programming modules may be configured using a software, a firmware, a hardware, or a combination of two or more of these.

The kernel 141 may control or manage system resources (e.g., the bus 110, the processor 120, or the memory 130, etc.) used for executing an operation or a function implemented in the rest of the programming modules, for example, the middleware 143, the API 145, or the application 147. Also, the kernel 141 may provide an interface for allowing the middleware 143, the API 145, or the application 147 to access an individual element of the electronic device 101 and control or manage the same.

The middleware 143 may perform a mediation role so that the API 145 or the application 147 may communicate with the kernel 141 to give and take data. Also, in connection with task requests received from the applications 147, the middleware 143 may perform a control (e.g., scheduling or load balancing) for a task request using, for example, a method of assigning priority that may use a system resource (e.g., the bus 110, the processor 120, or the memory 130, etc.) of the electronic device 101 to at least one application 134.

The API 145 is an interface for allowing the application 147 to control a function provided by the kernel 141 or the middleware 143, and may include at least one interface or function (e.g., an instruction) for file control, window control, image processing, or character control, etc.

The I/O interface 150 may transfer an instruction or data input from a user via an I/O unit (e.g., a sensor, a keyboard, or a touchscreen) to the processor 120, the memory 130, or the communication interface 170 via the bus 110, for example. For example, the I/O interface 150 may provide data regarding a user's touch input via the touchscreen to the processor 120. Also, the I/O interface 150 may, for example, output an instruction or data received via the bus 110 from the processor 120, the memory 130, or the communication interface 170 via the I/O unit (e.g., a speaker or a display). For example, the I/O interface 150 may output voice data processed by the processor 120 to a user via a speaker.

The display 160 may include, for example, a Liquid Crystal Display (LCD), a Light Emitting Diode (LED) display, an Organic Light Emitting Diode (OLED) display, a Micro Electro Mechanical System (MEMS) display, or an electronic paper display. The display 160 may display various types of contents (for example, text, images, videos, icons, or symbols) for users. The display 160 may include a touch screen, and may receive, for example, a touch, gesture, proximity, or hovering input by using an electronic pen or a part of the user's body.

The communication interface 170 may connect communication between the electronic device 101 and an external device (for example, the electronic device 104 or the server 106). For example, the communication interface 170 may be connected to a network 162 through wireless communication or wired communication, and may communicate with an external device.

The wireless communication may use at least one of, for example, Long Term Evolution (LTE), LTE-Advance (LTE-A), Code Division Multiple Access (CDMA), Wideband CDMA (WCDMA), Universal Mobile Telecommunications System (UMTS), WiBro (Wireless Broadband), and Global System for Mobile Communications (GSM) as a cellular communication protocol.

The wired communication may include, for example, at least one of universal serial bus (USB), high definition multimedia interface (HDMI), recommended standard 232 (RS-232), and plain old telephone service (POTS).

The network 162 may include at least one of communication networks such as a computer network (for example, a LAN or a WAN), the Internet, and a telephone network.

The electronic devices 102 and 104 may be devices of the same type as that the electronic device 101 or devices of different types from that of the electronic device 101. According to an embodiment, the server 106 may include a group of one or more servers. According to various embodiments, all or some of the operations executed in the electronic device 101 may be carried out in another electronic device or a plurality of electronic devices (for example, the electronic device 102 or 104 and the server 106). According to an embodiment, when the electronic device 101 should perform some functions or services automatically or by a request, the electronic device 101 may make a request for performing at least some functions related to the functions or services to another device (for example, the electronic device 102 or 104, or the server 106) instead of performing the functions or services by itself or additionally. The electronic device (for example, the electronic device 102 or 104, or the server 106) may carry out the functions requested by the electronic device 101 or additional functions and provide results thereof to the electronic device 101. The electronic device 101 may provide the requested functions or services to another electronic device based on the received results or after additionally processing the received results. To this end, for example, cloud computing, distributed computing, or client-server computing technology may be used.

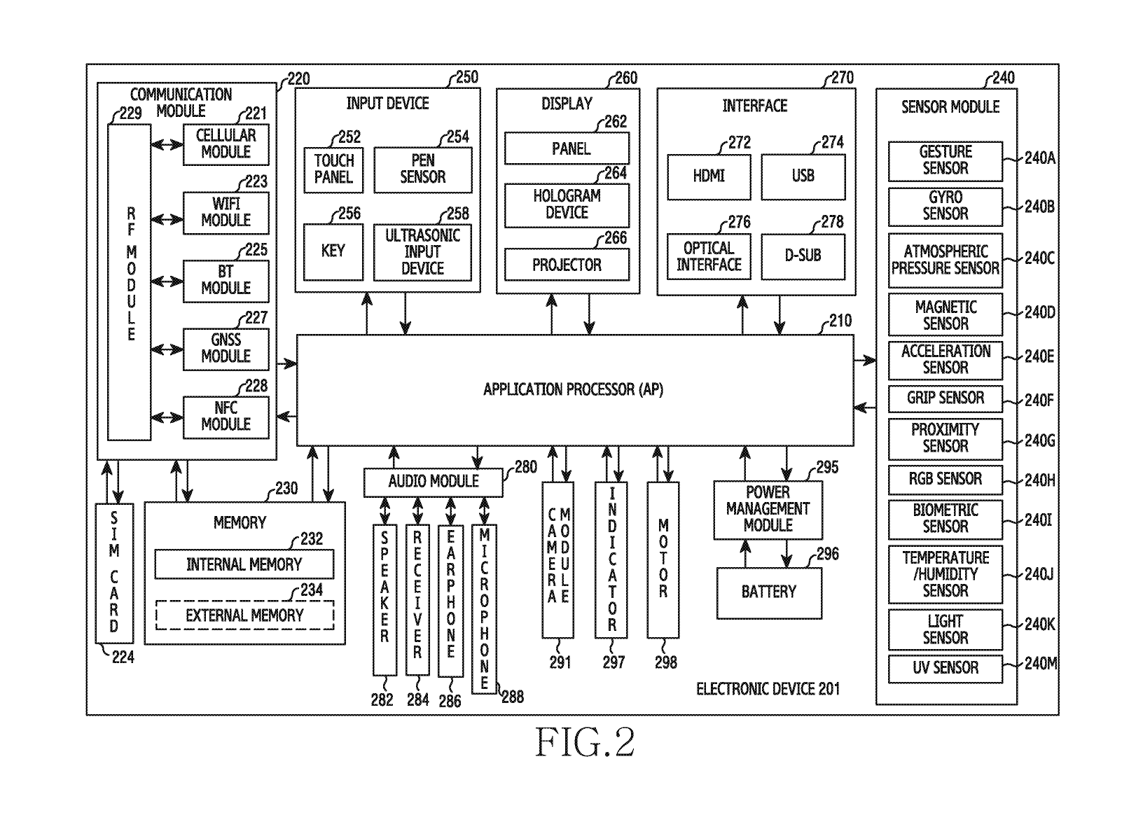

FIG. 2 is a block diagram 200 illustrating an electronic device 201 according to various embodiments of the present disclosure. The electronic device 201 may configure, for example, all or a portion of the electronic device 21 illustrated in FIG. 1. Referring to FIG. 2, the electronic device 201 may include one or more application processors (AP) 210, a communication module 220, a subscriber identification module (SIM) card 224, a memory 230, a sensor module 240, an input unit 250, a display 260, an interface 270, an audio module 280, a camera module 291, a power management module 295, a battery 296, an indicator 297, or a motor 298.

The AP 210 may drive an OS or an application to control a plurality of hardware or software elements connected to the AP 210, and perform various data processes including multimedia data and operations. The AP 210 may be implemented, for example, as a system on chip (SoC). According to an embodiment, the AP 210 may further include at least one of a graphic processing unit (GPU) or image signal processor. According to an embodiment, the AP 210 may be implemented to include at least a portion (e.g., the cellular module 221) of the above-described elements. Also, the AP 210 may stores data received from at least one of other elements or generated by at least one of other elements in a non-volatile memory.

The communication module 220 (e.g., the communication interface 160) may perform data transmission/reception in communication between the electronic device 201 (e.g., the electronic device 21) and other electronic devices (e.g., the electronic device 24 or the server 26) connected via a network. According to an embodiment, the communication module 220 may include a cellular module 221, a Wi-Fi module 223, a BT module 225, a GPS module 227, an NFC module 228, and a Radio Frequency (RF) module 229.

The cellular module 221 may provide voice communication, image communication, a short message service, or an Internet service, etc. via a communication network (e.g., LTE, LTE-A, CDMA, WCDMA, UMTS, WiBro, or GSM, etc.). Also, the cellular module 221 may perform discrimination and authentication of an electronic device within a communication network using, for example, a subscriber identify module (e.g., a SIM card 224). According to an embodiment, the cellular module 221 may perform at least a portion of functions that may be provided by the AP 210. According to an embodiment, the cellular module 221 may include a communication processor (CP). Also, the cellular module 221 may be, for example, implemented as a SoC. Though elements such as the cellular module 221 (e.g., a communication processor), the memory 230, or the power management module 295, etc. are illustrated as elements separated from the AP 210 in FIG. 2, according to an embodiment, the AP 210 may be implemented to include at least a portion (e.g., the cellular module 221) of the above-described elements.

Each of the Wi-Fi module 223, the BT module 225, the GPS module 227, or the NFC module 228 may include, for example, a processor for processing data transmitted/received via a relevant module. Though the cellular module 221, the Wi-Fi module 223, the BT module 225, the GPS module 227, or the NFC module 228 are illustrated as separate blocks in FIG. 2, according to an embodiment, at least a portion (e.g., two or more elements) of the cellular module 221, the Wi-Fi module 223, the BT module 225, the GPS module 227, or the NFC module 228 may be included in one Integrated Circuit (IC) or an IC package. For example, at least a portion (e.g., a communication processor corresponding to the cellular module 221 and a Wi-Fi processor corresponding to the Wi-Fi module 223) of processors corresponding to each of the cellular module 221, the Wi-Fi module 223, the BT module 225, the GPS module 227, or the NFC module 228 may be implemented as one SoC.

The RF module 229 may perform transmission/reception of data, for example, transmission/reception of an RF signal. The RF module 229 may include, for example, a transceiver, a power amp module (PAM), a frequency filter, or a low noise amplifier (LNA), etc., though not shown. Also, the RF module 229 may further include a part for transmitting/receiving an electromagnetic wave on a free space in wireless communication, for example, a conductor or a conducting line, etc. Though FIG. 2 illustrates the cellular module 221, the Wi-Fi module 223, the BT module 225, the GPS module 227, and the NFC module 228 share one RF module 229, according to an embodiment, at least one of the cellular module 221, the Wi-Fi module 223, the BT module 225, the GPS module 227, or the NFC module 228 may perform transmission/reception of an RF signal via a separate RF module.

The SIM card 224 may be a card including a subscriber identify module, and may be inserted into a slot formed in a specific position of the electronic device. The SIM card 224 may include unique identify information (e.g., integrated circuit card identifier (ICCID)) or subscriber information (e.g., international mobile subscriber identity (IMSI)).

The memory 230 (e.g., the memory 20) may include a built-in memory 232 or an external memory 234. The built-in memory 232 may include, for example, at least one of a volatile memory (e.g., dynamic RAM (DRAM), static RAM (SRAM), synchronous dynamic RAM (SDRAM)) and a non-volatile memory (e.g., one time programmable ROM (OTPROM), programmable ROM (PROM), erasable and programmable ROM (EPROM), electrically erasable and programmable ROM (EEPROM), mask ROM, flash ROM, NAND flash memory, NOR flash memory, etc.).

According to an embodiment, the built-in memory 232 may be a Solid State Drive (SSD). The external memory 234 may further include a flash drive, for example, compact flash (CF), secure digital (SD), micro secure digital (Micro-SD), mini secure digital (Mini-SD), extreme digital (xD), or a memory stick. The external memory 234 may be functionally connected with the electronic device 201 via various interfaces. According to an embodiment, the electronic device 201 may further include a storage device (or a storage medium) such as a hard drive.

The sensor module 240 may measure a physical quantity or detect an operation state of the electronic device 201, and convert the measured or detected information to an electric signal. The sensor module 240 may include, for example, at least one of a gesture sensor 240A, a gyro sensor 240B, an atmospheric pressure sensor 240C, a magnetic sensor 240D, an acceleration sensor 240E, a grip sensor 240F, a proximity sensor 240G, a color sensor 240H (e.g., RGB (red, green, blue) sensor), a living body sensor 240I, a temperature/humidity sensor 240J, an illuminance sensor 240K, or an ultra violet (UV) sensor 240M. Additionally or alternatively, the sensor module 240 may include, for example, an E-nose sensor (not shown), an electromyography (EMG) sensor (not shown), an electroencephalogram (EEG) sensor (not shown), an electrocardiogram (ECG) sensor (not shown), an infrared (IR) sensor (not shown), an iris sensor (not shown), or a fingerprint sensor (not shown), etc. The sensor module 240 may further include a control circuit for controlling at least one sensor belonging thereto.

The input unit 250 may include a touch panel 252, a (digital) pen sensor 254, a key 256, or an ultrasonic input unit 258. The touch panel 252 may recognize a touch input using at least one of capacitive, resistive, infrared, or ultrasonic methods. Also, the touch panel 252 may further include a control circuit. A capacitive touch panel may perform detection by a physical contact or proximity recognition. The touch panel 252 may further include a tactile layer. In this case, the touch panel 252 may provide a tactile reaction to a user.

The (digital) pen sensor 254 may be implemented using, for example, a method which is the same as or similar to receiving a user's touch input, or using a separate sheet for detection. The key 256 may include, for example, a physical button, an optical key or keypad. The ultrasonic input unit 258 is a unit for recognizing data by detecting a sound wave using a microphone (e.g., a microphone 288) in the electronic device 201 via an input tool generating an ultrasonic signal, and enables wireless recognition. According to an embodiment, the electronic device 201 may receive a user input from an external device (e.g., a computer or a server) connected to the communication module 220 using the communication module 220.

The display 260 (e.g., the display 150) may include a panel 262, a hologram device 264, or a projector 266. The panel 262 may be, for example, a liquid crystal display (LCD), or an active-matrix organic light-emitting diode (AM-OLED), etc. The panel 262 may be implemented, for example, such that it is flexible, transparent, or wearable. The panel 262 may be configured as one module together with the touch panel 252. The hologram device 264 may show a three-dimensional image in the air using interferences of light. The projector 266 may project light onto a screen to display an image. The screen may be positioned, for example, inside or outside the electronic device 201. According to an embodiment, the display 260 may further include a control circuit for controlling the panel 262, the hologram device 264, or the projector 266.

The interface 270 may include, for example, a high-definition multimedia interface (HDMI) 272, a universal serial bus (USB) 274, an optical interface 276, or a D-subminiature (D-sub) 278. The interface 270 may be included, for example, in the communication interface 160 illustrated in FIG. 1. Additionally or alternatively, the interface 270 may include, for example, a mobile high-definition link (MHL) interface, a secure digital (SD) card/multi-media card (MMC) interface, or an infrared data association (IrDA) standard interface.

The audio module 280 may convert a sound and an electric signal in dual directions. At least a partial element of the audio module 280 may be included, for example, in the I/O interface 140 illustrated in FIG. 1. The audio module 280 may process sound information input or output via, for example, a speaker 282, a receiver 284, an earphone 286, or a microphone 288, etc.

The camera module 291 is a device that may shoot a still image and a moving picture. According to an embodiment, the camera module 291 may include one or more image sensors (e.g., a front sensor or a rear sensor), a lens (not shown), an image signal processor (ISP) (not shown), or a flash (not shown) (e.g., an LED or xenon lamp).

The power management module 295 may manage power of the electronic device 201. Though not shown, the power management module 295 may include, for example, a power management integrated circuit (PMIC), a charger integrated circuit (IC), or a battery or a battery or fuel gauge.

The PMIC may be mounted, for example, inside an integrated circuit or a SoC semiconductor. A charging method may be classified into a wired charging method and a wireless charging method. The charging IC may charge a battery and reduce an amount of or prevent introduction of an overvoltage or an overcurrent from a charger. According to an embodiment, the charging IC may include a charging IC for at least one of the wired charging method and the wireless charging method. The wireless charging method may be, for example, a magnetic resonance method, a magnetic induction method, or an electromagnetic wave method, etc., and may additionally include an additional circuit for wireless charging, for example, a circuit such as a coil loop, a resonance circuit, or a rectifier, etc.

The battery gauge may measure, for example, a remnant of the battery 296, a voltage, a current, or a temperature while charging. The battery 296 may store or generate electricity, and supply power to the electronic device 201 using the stored or generated electricity. The battery 296 may include, for example, a rechargeable battery or a solar battery.

The indicator 297 may display a specific state of the electronic device 201 or a portion thereof (e.g., the AP 210), for example, a booting state, a message state, or a charging state, etc. The motor 298 may convert an electric signal to mechanical vibration. Though not shown, the electronic device 201 may include a processor (e.g., a GPU) for supporting a mobile TV. The processor for supporting the mobile TV may process media data corresponding to standards, for example, such as digital multimedia broadcasting (DMB), digital video broadcasting (DVB), or a media flow, etc.

The aforementioned elements of the electronic device according to various embodiments of the present disclosure may be constituted by one or more components, and the name of the corresponding element may vary with a type of electronic device. The electronic device according to various embodiments of the present disclosure may include at least one of the aforementioned elements. Some elements may be omitted or other additional elements may be further included in the electronic device. Further, some of the components of the electronic device according to the various embodiments of the present disclosure may be combined to form a single entity, and thus, may equivalently execute functions of the corresponding elements prior to the combination.

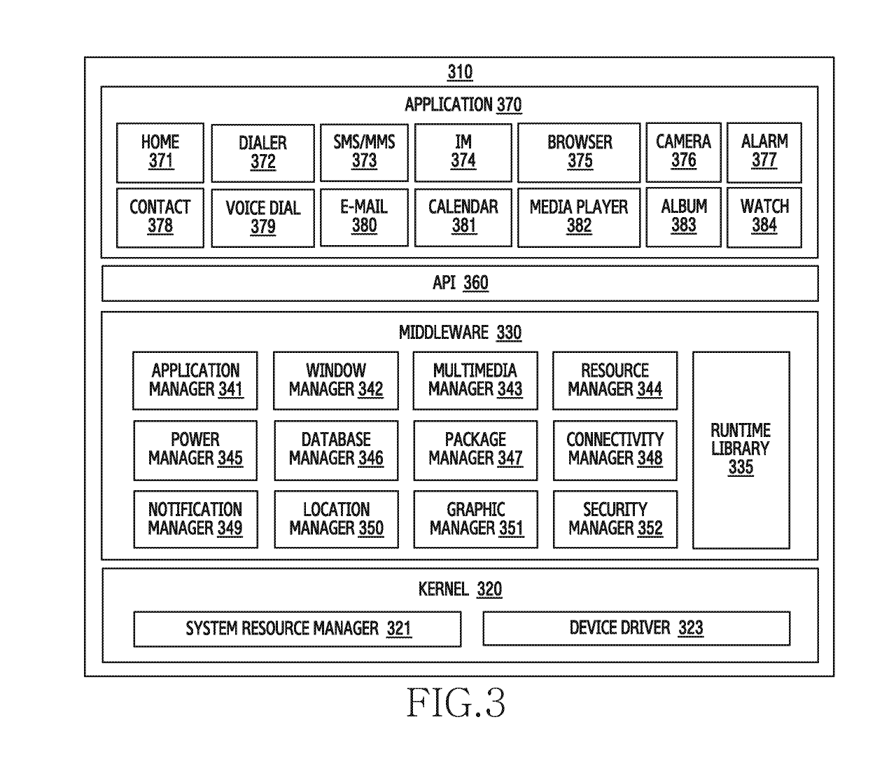

FIG. 3 is a block diagram of a program module 310 according to various embodiments of the present disclosure.

According to an embodiment, the program module 310 (for example, the programs 140) may include an Operating System (OS) for controlling resources related to the electronic device (for example, the electronic device 100) and/or various applications (for example, the application programs 147) executed in the operating system. The operating system may be, for example, Android®, iOS®, Windows®, Symbian®, Tizen®, Bada®, or the like.

The programming module 310 may include a kernel 320, middleware 330, an API 360, and/or applications 370. At least some of the program module 310 may be preloaded in the electronic device or downloaded from the server.

The kernel 320 (for example, the kernel 141 of FIG. 1) may include, for example, a system resource manager 331 or a device driver 333. The system resource manager 331 may control, allocate, or collect the system resources. According to an embodiment, the system resource manager 331 may include a process management unit, a memory management unit, or a file system management unit. The device driver 333 may include, for example, a display driver, a camera driver, a Bluetooth driver, a shared-memory driver, a USB driver, a keypad driver, a WiFi driver, an audio driver, or an Inter-Process Communication (IPC) driver.

The middleware 330 may provide a function required by the applications 370 in common or provide various functions to the applications 370 through the API 360 so that the applications 370 can efficiently use limited system resources within the electronic device. According to an embodiment, the middleware 330 (for example, the middleware 143) may include, for example, at least one of a runtime library 335, an application manager 341, a window manager 342, a multimedia manager 343, a resource manager 344, a power manager 345, a database manager 346, a package manager 347, a connectivity manager 348, a notification manager 349, a location manager 350, a graphic manager 351, and a security manager 352.

The runtime library 335 may include, for example, a library module that a compiler uses to add new functions through a programming language while the application 370 is executed. The runtime library 335 may perform input/output management, memory management, or a function for an arithmetic function.

The application manager 341 may manage, for example, a life cycle of at least one of the applications 370. The window manager 342 may manage Graphical User Interface (GUI) resources used by a screen. The multimedia manager 343 may grasp formats required for the reproduction of various media files, and may perform an encoding or decoding of the media file by using a codec suitable for the corresponding format. The resource manager 344 may manage resources such as a source code, a memory, and a storage space of at least one of the applications 370.

The power manager 345 may operate together with a Basic Input/Output System (BIOS) to manage a battery or power and may provide power information required for the operation of the electronic device. The database manager 346 may generate, search for, or change a database to be used by at least one of the applications 370. The package manager 347 may manage the installation or the updating of applications distributed in the form of package file.

The connectivity manager 348 may manage wireless connection of, for example, Wi-Fi or Bluetooth. The notification manager 349 can display or notify of an event such as an arrival message, promise, proximity notification, and the like in such a way that does not disturb a user. The location manager 350 may manage location information of the electronic device. The graphic manager 351 may manage graphic effects to be provided to a user and user interfaces related to the graphic effects. The security manager 352 may provide all security functions required for system security or user authentication. According to an embodiment, when the electronic device (for example, electronic device 100) has a call function, the middleware 330 may further include a telephony manager for managing a voice call function or a video call function of the electronic device.

The middleware 330 may include a middleware module for forming a combination of various functions of the aforementioned components. The middleware 330 may provide modules specialized according to types of operating systems in order to provide differentiated functions. Further, the middleware 330 may dynamically remove some of the existing components or add new components.

The API 360 (for example, the API 145) is, for example, a set of API programming functions, and a different configuration thereof may be provided according to an operating system. For example, Android or iOS may provide one API set per platform, and Tizen may provide two or more API sets per platform.

The applications 370 (for example, the application programs 147) may include, for example, one or more applications which can provide functions such as home 371, dialer 372, SMS/MMS 373, Instant Message (IM) 374, browser 375, camera 376, alarm 377, contacts 378, voice dialer 379, email 380, calendar 381, media player 382, album 383, clock 384, health care (for example, measure exercise quantity or blood sugar), or environment information (for example, atmospheric pressure, humidity, or temperature information).

According to an embodiment, the applications 370 may include an application (hereinafter, referred to as an “information exchange application” for convenience of the description) supporting information exchange between the electronic device (for example, the electronic device 100) and an external electronic device. The information exchange application may include, for example, a notification relay application for transferring predetermined information to an external electronic device or a device management application for managing an external electronic device.

For example, the notification relay application may include a function of transferring, to the external electronic device, notification information generated from other applications of the electronic device 100 (for example, an SMS/MMS application, an e-mail application, a health management application, or an environmental information application). Further, the notification relay application may receive notification information from, for example, a control device and provide the received notification information to the user. The device management application may manage (for example, install, delete, or update), for example, a function for at least a part of the external electronic device communicating with the electronic device (for example, turning on/off the external electronic device itself (or some elements thereof) or adjusting brightness (or resolution) of a display), applications executed in the external electronic device, or services provided from the external electronic device (for example, a telephone call service or a message service).

According to an embodiment, the applications 370 may include an application (for example, health management application) designated according to attributes of the external electronic device (for example, attributes of the electronic device such as the type of electronic device which corresponds to a mobile medical device). According to an embodiment, the applications 370 may include an application received from the external electronic devices (for example, the server or the electronic device). According to an embodiment, the applications 370 may include a preloaded application or a third party application which can be downloaded from the server. The names of the components of the program module 310 according to the embodiment illustrated in FIG. 3 may vary according to the type of operating system.

According to various embodiments, at least some of the programming module 310 may be implemented by software, firmware, hardware, or a combination of two or more thereof. At least some of the programming module 310 may be implemented (for example, executed) by, for example, the processor (for example, the application program). At least some of the programming module 310 may include, for example, a module, program, routine, sets of instructions, or process for performing one or more functions.

The term “module” as used herein may, for example, mean a unit including one of hardware, software, and firmware or a combination of two or more of them. The “module” may be interchangeably used with, for example, the term “unit”, “logic”, “logical block”, “component”, or “circuit”. The “module” may be a minimum unit of an integrated component element or a part thereof. The “module” may be a minimum unit for performing one or more functions or a part thereof. The “module” may be mechanically or electronically implemented. For example, the “module” according to the present disclosure may include at least one of an Application-Specific Integrated Circuit (ASIC) chip, a Field-Programmable Gate Arrays (FPGA), and a programmable-logic device for performing operations which has been known or are to be developed hereinafter.

According to various embodiments, at least some of the devices (for example, modules or functions thereof) or the method (for example, operations) according to the present disclosure may be implemented by a command stored in a computer-readable storage medium in a programming module form. The instruction, when executed by a processor (e.g., the processor 120), may cause the one or more processors to execute the function corresponding to the instruction. The computer-readable storage medium may be, for example, the memory 130.

The computer readable recoding medium may include a hard disk, a floppy disk, magnetic media (e.g., a magnetic tape), optical media (e.g., a Compact Disc Read Only Memory (CD-ROM) and a Digital Versatile Disc (DVD)), magneto-optical media (e.g., a floptical disk), a hardware device (e.g., a Read Only Memory (ROM), a Random Access Memory (RAM), a flash memory), and the like. In addition, the program instructions may include high class language codes, which can be executed in a computer by using an interpreter, as well as machine codes made by a compiler. The aforementioned hardware device may be configured to operate as one or more software modules in order to perform the operation of the present disclosure, and vice versa.

The programming module according to the present disclosure may include one or more of the aforementioned components or may further include other additional components, or some of the aforementioned components may be omitted. Operations executed by a module, a programming module, or other component elements according to various embodiments of the present disclosure may be executed sequentially, in parallel, repeatedly, or in a heuristic manner. Further, some operations may be executed according to another order or may be omitted, or other operations may be added.

Various embodiments disclosed herein are provided merely to easily describe technical details of the present disclosure and to help the understanding of the present disclosure, and are not intended to limit the scope of the present disclosure. Accordingly, the scope of the present disclosure should be construed as including all modifications or various other embodiments based on the technical idea of the present disclosure.

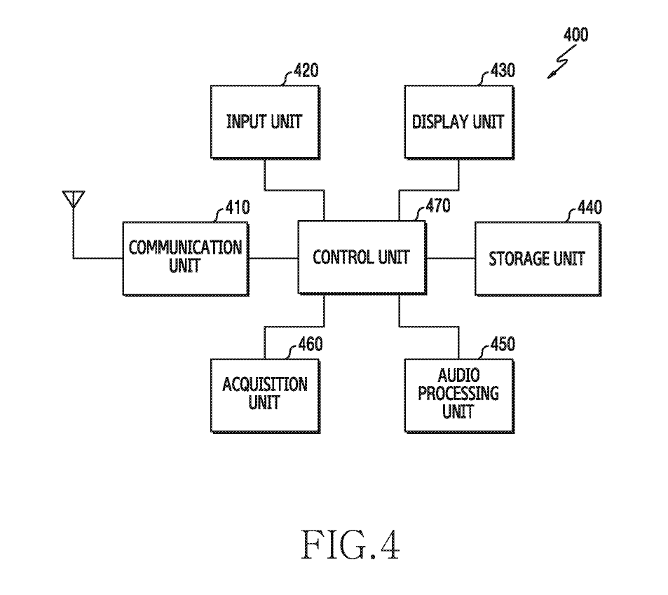

FIG. 4 is a block diagram illustrating an electronic device 400 according to various embodiments of the present disclosure.

Referring to FIG. 4, the electronic device 400 according to various embodiments of the present disclosure may be an electronic device 101 and an electronic device 201. According to an embodiment, the electronic device 400 may include a communication unit 410, an input unit 420, a display unit 430, a storage unit 440, and an audio processing unit 450, an acquisition unit 460, and a control unit 470.

According to various embodiments, the communication unit 410 (e.g., a communication interface 170, a communication module 220) may perform communication in the electronic device 400. According to various embodiments, the communication unit 410 may perform communication with an external device (not shown) through various communication schemes. For example, the external device may include electronic devices (e.g., an electronic device 102 and an electronic device 104), a base station, a server (e.g., a server 106), and a satellite. According to an embodiment, the communication unit 410 may perform communication using at least one communication scheme of wireless communication and wired communication. To this end, the communication unit 410 may access at least one of a mobile communication network and a data communication network. For another example, the communication unit 410 may perform short range communication. Further, the communication scheme may include Long Term Evolution (LTE), Wideband Code Division Multiple Access (WCDMA), Global System for Mobile communications (GSM), Wi-Fi (Wireless Fidelity), Bluetooth, and Near Field Communication (NFC).

According to various embodiments, the input unit 420 (e.g., an input/output interface 150) may generate input data in the electronic device 400. According to an embodiment, the input unit 420 may generate input data in response to an input of a user of the electronic device 400. According to various embodiments, the input unit 420 may include at least one input means (e.g., a keypad, a dome switch, a physical button, a touch panel, a jog & shuttle, a sensor, etc.).

According to various embodiments, the display unit 430 may output display data. According to an embodiment, the display unit 430 may display feedback information corresponding to a user's input, an emotion of a user, etc. For example, the display unit 430 may include a Liquid Crystal Display (LCD), a Light Emitting Diode (LED) display, an Organic LED (OLED) display, a Micro Electro-Mechanical System (MEMS) display, and an electronic paper display. According to an embodiment, the display unit 430 may be combined with the input unit 420 and implemented in a touch screen.

According to various embodiments, the storage unit 440 (e.g., a memory 130 and a memory 230) may store an operation program of the electronic device 400. According to an embodiment, the storage unit 440 may store a program (e.g., an application) for performing various functions. According to various embodiments, the storage unit 440 may store data generated while programs are being performed.

According to various embodiments, the storage unit 440 may store data used for determining an emotion of a user. According to an embodiment, the storage unit 440 may store reference data for determining at least one emotion among a positive emotion, a negative emotion, and a neutral emotion. For example, the reference data may be associated with at least one of the number of feature points and a distribution type of a feature point defined for at least one emotion.

According to various embodiments, the audio processing unit 450 may process an external voice signal, and process audio data generated by the electronic device 400 to be output. According to an embodiment, the audio processing unit 450 may process a sound signal input through a microphone (e.g., a microphone 288) into voice data to provide the same to the control unit 470, and convert the data provided by the control unit 470 into a voice signal to output the same through a speaker (e.g., a speaker 282). According to various embodiments, the audio processing unit 450 may analyze a voice of the user and recognize the same as an input for controlling a function of the electronic device 400. For example, the audio processing unit 450 may analyze a voice of the user input through a microphone (e.g., a microphone 288).

According to various embodiments, the acquisition unit 460 may acquire emotion information for determining an emotion of the user. According to an embodiment, the acquisition unit 460 may acquire an image of at least a part of the user's body through an image acquisition module (e.g., a camera module 291). According to another embodiment, the acquisition unit 460 may acquire at least a part of a voice vocalized by the user through the audio processing unit 450 (e.g., a microphone). According to still another embodiment, the acquisition unit 460 may measure biometric information on the user through a sensor (e.g., a biometric sensor (e.g., a heartbeat sensor, a blood pressure sensor, or a body temperature sensor)).

According to various embodiments, the control unit 470 may control an overall operation of the electronic device 400. According to an embodiment, the control unit 470 may control elements (e.g., the communication unit 410, the input unit 420, the display unit 430, the storage unit 440, the audio processing unit 450, and the acquisition unit 460) of the electronic device 400.

According to various embodiments, the control unit 470 may recognize a voice of the user and perform an operation corresponding to a recognition result. According to an embodiment, the control unit 470 may identify a keyword based on a voice recognition result, and perform a search operation corresponding to the keyword.

According to various embodiments, the control unit 470 may determine an emotion of the user based on information acquired through the acquisition unit 460, and generate feedback information corresponding to the emotion. According to an embodiment, the control unit 470 may generate different feedback information for a function being performed according to the emotion of the user (e.g., a positive emotion, a negative emotion, and a neutral emotion). For example, the control unit 470 may generate feedback information for maintaining the currently performed function, in response to a positive emotion. For another example, the control unit 470 may generate feedback information for performing another function instead of the currently performed function, in response to a negative emotion. According to various embodiments, the control unit 470 may control at least one of the display unit 430 and the audio processing unit 450, so as to output generated feedback information.

According to various embodiments, an operation of the communication unit 410, input unit 420, display unit 430, storage unit 440, audio processing unit 450, acquisition unit 460, and control unit 470 may be performed by at least one piece of software.

According to various embodiments, the control unit 470 may be a processor 120 of at least one processor (e.g., the electronic device 101), and include at least one module for performing the described operation.

Although not illustrated, according to various embodiments, the communication unit 410, the input unit 420, the display unit 430, the storage unit 440, the audio processing unit 450, the acquisition unit 460, and the control unit 470 may be included in a plurality of processors (or chips). For example, the communication unit 410 may be included in a first processor (or a first chip). The input unit 420, the display unit 430, and the acquisition unit 460 may be included in a second processor (or a second chip). Further, the audio processing unit 450 and the control unit 470 may be included in a third processor (or a third chip).

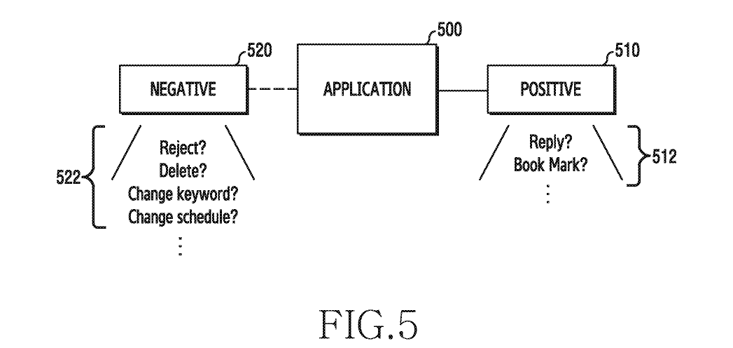

FIG. 5 is a diagram illustrating a feedback generating operation of an electronic device 400 according to various embodiments of the present disclosure. According to an embodiment, the electronic device 400 may be the electronic device 101, the electronic device 201, the processor 120, or the control unit 470.

According to various embodiments, the electronic device 400 may control execution of an application 500 based on a user's input.

According to various embodiments, the electronic device 400 may control the application 500 executed in response to an emotion of the user. According to an embodiment, the electronic device 400 may perform a process such that the currently performed function of the application 500 is controlled in response to a determination of a positive emotion 510. According to another embodiment, the electronic device 400 may perform a control such that another function, instead of the currently performed function of the application 500, is performed in response to a determination of a negative emotion 520. According to various embodiments, the electronic device 400 may control the application 500 executed after outputting feedback information 512 corresponding to the positive emotion 510 or feedback information 522 corresponding to the negative emotion 520.

According to an embodiment, in a state in which a call reception event has occurred, the electronic device 400 may output feedback information that inquires whether or not to respond to call reception, or feedback information that inquires whether or not to reject call reception.

According to another embodiment, in a state in which a web search result has been output, the electronic device 400 may output feedback information that inquires whether or not to change a keyword, or feedback information that inquires whether or not to bookmark the web search result.

An electronic device according to various embodiments may include a memory and a processor electrically connected to the memory. According to an embodiment, the processor may perform a control such that at least one function for the electronic device is performed, an emotion of a user for the performed function is determined, and a scheme for controlling the performed function according to the emotion of the user is output.

According to various embodiments, the processor may perform a control such that the performed function is controlled in response to a determination of a positive emotion of the user.

According to various embodiments, the processor may perform a control such that a function different from the performed function is controlled in response to determination of a negative emotion of the user.

According to various embodiments, the electronic device may include a camera module. According to an embodiment, the processor may perform a control such that the emotion of the user is determined by analyzing an image acquired through the camera module. According to an embodiment, the image may include at least a part of the user's face.

According to various embodiments, the electronic device may include a sensor. According to an embodiment, the processor may perform a control such that the emotion of the user is determined by measuring biometric information of the user through the sensor. According to an embodiment, the processor may perform a control such that at least one of blood pressure, heartbeats, and body temperature is measured as the biometric information.

According to various embodiments, the processor may perform a control such that a function of the electronic device is controlled based on an emotion of the user which is additionally determined after the scheme is output.

According to various embodiments, the processor may perform a control such that the emotion of the user is determined in response to detecting a voice input, after performing the function.

According to various embodiments, the processor may perform a control such that a scheme for controlling the performed function is output using at least one of audio data and text data.

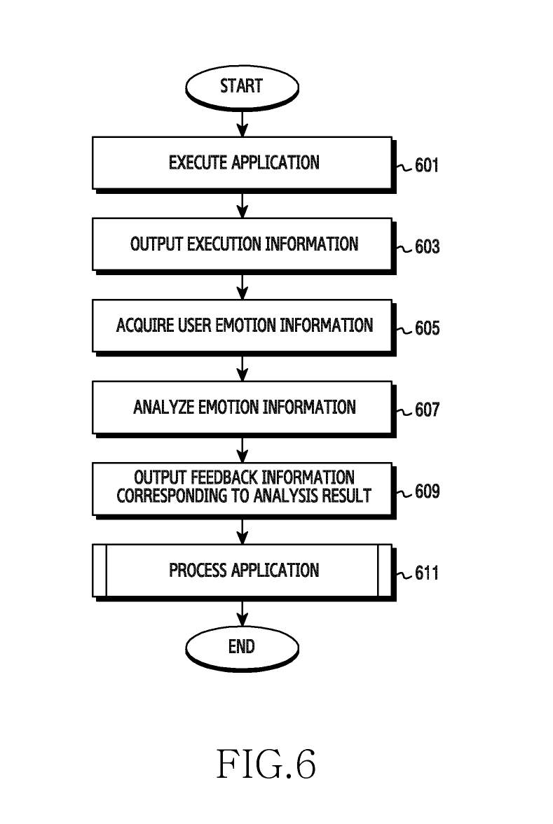

FIG. 6 is a flow diagram illustrating a performance procedure of an application processing method of an electronic device according to various embodiments of the present disclosure. According to an embodiment, the electronic device 400 may be the electronic device 101, the electronic device 201, the processor 120, or the control unit 470.

As shown in operation 601, the electronic device 400 may execute an application. According to an embodiment, the electronic device 400 may detect an input of the user and execute the application. According to various embodiments, the electronic device 400 may detect an input of the user such that the executed application is controlled. According to an embodiment, the input of the user may include a key input, a voice input, a gesture input, etc. For example, the executed application may be a voice recognition application that controls a function of the electronic device 400 based on a voice input of the user.

As shown in operation 603, the electronic device 400 may output execution information of the application. For example, execution information may be associated with an operation of the application. According to an embodiment, the electronic device 400 may output, as execution information, a search result by a search application (e.g., a web search, a weather search, and a schedule search). According to another embodiment, the electronic device 400 may output, as execution information, incoming event information (e.g., calling information) of a communication related application.

As shown in operation 605, the electronic device 400 may acquire emotion information for determining an emotion of the user. According to an embodiment, the emotion is the emotion of the user expressed in response to the output execution information, and may include a positive emotion and a negative emotion. According to various embodiments, the emotion may include a neutral emotion. The neutral emotion may be a normal facial expression of the user, or may be a facial expression showing no change during a predetermined time.

According to various embodiments, information for determining an emotion may be image information, and the electronic device 400 may acquire an image for at least a part of the user's body by operating the image acquisition module (e.g., a camera module 291). According to an embodiment, the electronic device 400 may acquire an image for at least a part of the user's face in order to recognize a facial expression of the user. According to various embodiments, information for determining an emotion may be audio information, and the electronic device 400 may acquire at least a part of the user's voice by operating the audio processing module (e.g., a microphone 288). According to still another embodiment, information for determining an emotion may be biometric information, and the electronic device 400 may measure biometric information of the user by operating at least one sensor (e.g., a heartbeat sensor, a blood pressure sensor, or a body temperature sensor).

As shown in operation 607, the electronic device 400 may determine an emotion of the user by analyzing acquired emotion information. According to various embodiments, the electronic device 400 may determine an emotion by comparing an image recognition result with a predetermined condition when image-type emotion information is acquired. For example, the electronic device 400 may extract a feature point through an image analyzing operation, and recognize a facial expression of the user based on the extracted feature point. Here, the electronic device 400 may make a determination of a positive emotion in response to recognition of the facial expression of the user corresponding to a condition associated with joy, pleasure, and so on (e.g., a laughing face, a joyful face, a face when humming, etc.). For another example, the electronic device 400 may make a determination of a negative emotion in response to recognition of a facial expression of the user corresponding to a condition associated with sadness, anger, rage, and so on (e.g., a frowning face, a crying face, a resentful face, a sad face etc.). According to various embodiments, the electronic device 400 may identify an emotion by comparing an audio data analysis result with a predetermined condition when audio-type emotion information is acquired. For example, the electronic device 400 may recognize vibration, speed, and volume of the user's voice through an audio analyzing operation. Here, the electronic device 400 may make a determination of a positive emotion in response to recognition of a voice associated with joy, pleasure, and so on. For another example, electronic device 400 may make a determination of a negative emotion in response to recognition of a voice associated with sadness, anger, rage, and so on. According to various embodiments, the electronic device 400 may identify an emotion by comparing a biometric information analysis result with a predetermined condition when biometric information (e.g., blood pressure, body temperature, heartbeats, etc.) is acquired. For example, the electronic device 400 may make a determination of a positive emotion in response to recognition of measuring a body state associated with joy, pleasure, and so on. For another example, the electronic device 400 may make a determination of a negative emotion in response to recognition of measuring a body state associated with sadness, anger, rage, and so on.

As shown in operation 609, the electronic device 400 may output feedback information corresponding to an analysis result. According to various embodiments, the electronic device 400 may output feedback information corresponding to a positive emotion in response to a determination of a positive emotion. For example, the electronic device 400 may output feedback information for processing the currently output execution information. According to various embodiments, the electronic device 400 may output feedback information corresponding to a negative emotion in response to a determination of a negative emotion. For example, the electronic device 400 may output feedback information for outputting another execution information instead of the currently output execution information. According to various embodiments, the electronic device 400 may output feedback information in at least one scheme among a text scheme, an audio scheme, and a vibration scheme. When feedback information is output in a vibration scheme, the electronic device 400 may modify the intensity of vibration, the number of vibrations, and so on according to a determined emotion. According to various embodiments, the electronic device 400 may output feedback information corresponding to a positive emotion or feedback information corresponding to a negative emotion, in response to a determination of a neutral emotion. Surely, the electronic device 400 may output feedback information corresponding to a neutral emotion in response to a determination of a neutral emotion.

As shown in operation 611, the electronic device 400 may process the application. According to various embodiments, the electronic device 400 may perform an operation to maintain outputting execution information after outputting feedback information that notifies of a positive emotion. According to various embodiments, the electronic device 400 may perform an operation to stop outputting execution information after outputting feedback information that notifies of a negative emotion.

According to various embodiments, the electronic device 400 may process the application in response to an input of the user detected after feedback information is output. According to another embodiment, the electronic device 400 may additionally acquire emotion information, analyze the same, and then process the application, after outputting feedback information.

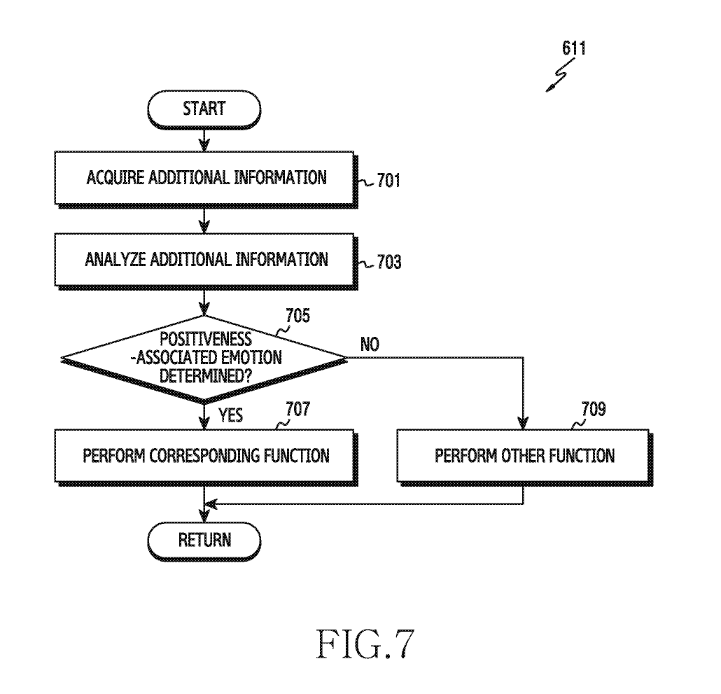

FIG. 7 is a flow diagram illustrating a performance procedure of a feedback information output method of an electronic device according to various embodiments of the present disclosure. According to an embodiment, the electronic device 400 may be the electronic device 101, the electronic device 201, the processor 120, or the control unit 470.

According to various embodiments, the performance procedure of the feedback information output method may be a detailed operation for operation 609 illustrated in FIG. 6.

As shown in operation 701, the electronic device 400 may acquire additional information. According to various embodiments, the additional information may be emotion information additionally acquired for determining an emotion of the user after feedback information is output.

As shown in operation 703, the electronic device 400 may perform an operation that analyzes the additional information. According to an embodiment, the electronic device 400 may determine an emotion of the user after outputting feedback information, by analyzing the additional information. According to an embodiment, the electronic device 400 may determine whether a positive emotion is maintained even after feedback information has been output. According to another embodiment, the electronic device 400 may determine whether a positive emotion is switched to a negative emotion after feedback information has been output. According to still another embodiment, the electronic device 400 may determine whether a negative emotion is maintained even after feedback information has been output. According to another embodiment, the electronic device 400 may determine whether a negative emotion is switched to a positive emotion feedback information has been output.

As shown in operation 705, the electronic device 400 may determine whether a determination of a positiveness associated emotion has been made.

When a determination of a positiveness associated emotion has been made in operation 705, the electronic device 400 may perform a corresponding function, as shown in operation 707. According to an embodiment, the electronic device 400 may maintain the currently performed function.

When a determination of a negativeness associated emotion has been made in operation 705, the electronic device 400 may perform another function as shown in operation 709.

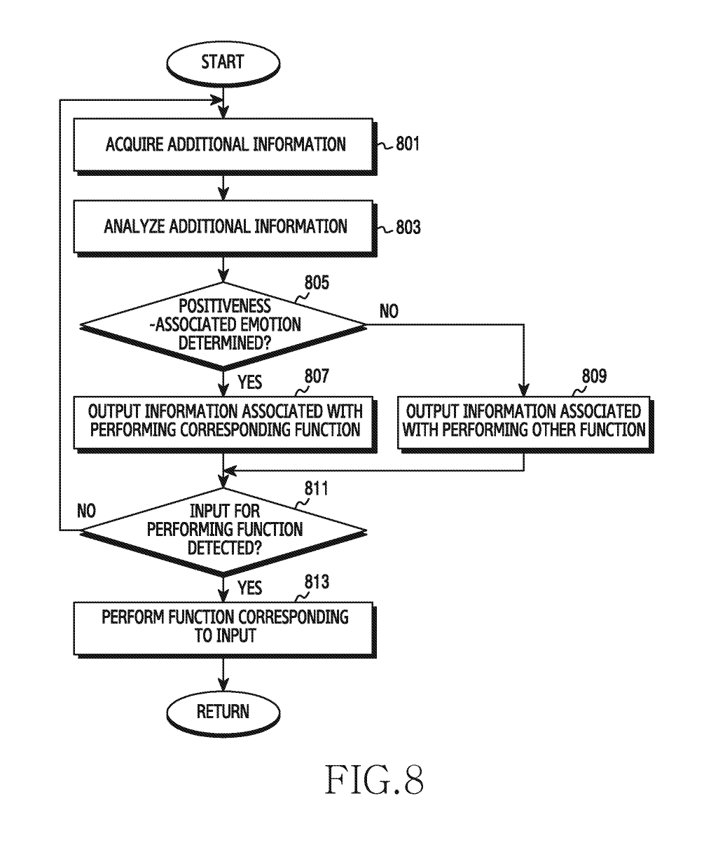

FIG. 8 is a flow diagram illustrating another performance procedure of a feedback information output method of an electronic device 400 according to various embodiments of the present disclosure. According to an embodiment, the electronic device 400 may be the electronic device 101, the electronic device 201, the processor 120, or the control unit 470.

According to various embodiments, the performance procedure of the feedback information output method may be a detailed operation for the operation 609 illustrated in FIG. 6.

As shown in operation 801, the electronic device 400 may acquire additional information. According to various embodiments, the additional information may be emotion information additionally acquired for determining an emotion of the user after feedback information is output. According to an embodiment, the electronic device 400 may acquire, as additional information, at least one of image information, audio information, and biometric information on the user.

As shown in operation 803, the electronic device 400 may perform an operation that analyzes additional information. According to various embodiments, the electronic device 400 may determine an emotion of the user after feedback information is output, by analyzing additional information.

As shown in operation 805, the electronic device 400 may determine that a determination of a positiveness associated emotion has been determined.

When a determination of a positiveness associated emotion has been made in operation 805, the electronic device 400 may output feedback information associated with performing a corresponding function, as shown in operation 807. For an embodiment, the electronic device 400 may output feedback information notifying that the currently performed function is maintained.

When a determination of a negativeness associated emotion has been made in operation 805, the electronic device 400 may output feedback information associated with another function, as shown in operation 809. For an embodiment, the electronic device 400 may output feedback information notifying that another function is performed instead of the currently performed function.

As shown in operation 811, the electronic device 400 may determine whether an input for performing a function is detected in a state where feedback information has been output.

As shown in operation 813, the electronic device 400 may perform a function corresponding to the input. For example, the electronic device 400 may maintain the currently performed function or perform another function instead of the currently performed function, in response to the input.

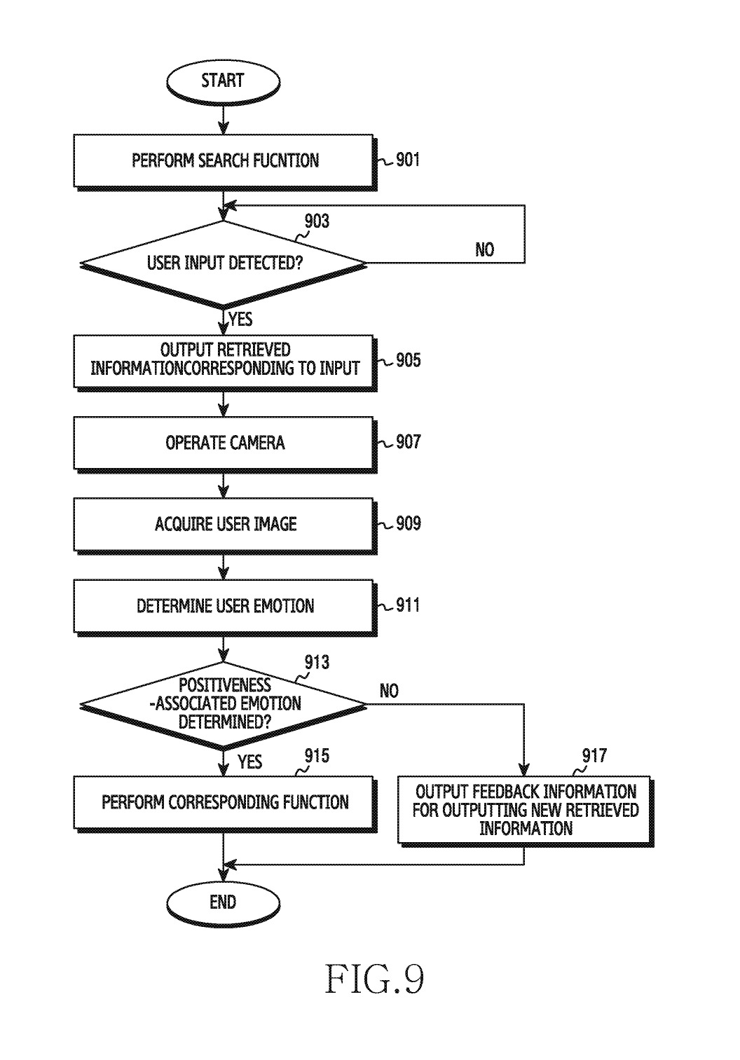

FIG. 9 is a flow diagram illustrating a performance procedure of a search function providing method of an electronic device according to various embodiments of the present disclosure. According to an embodiment, the electronic device 400 may be the electronic device 101, the electronic device 201, the processor 120, or the control unit 470.

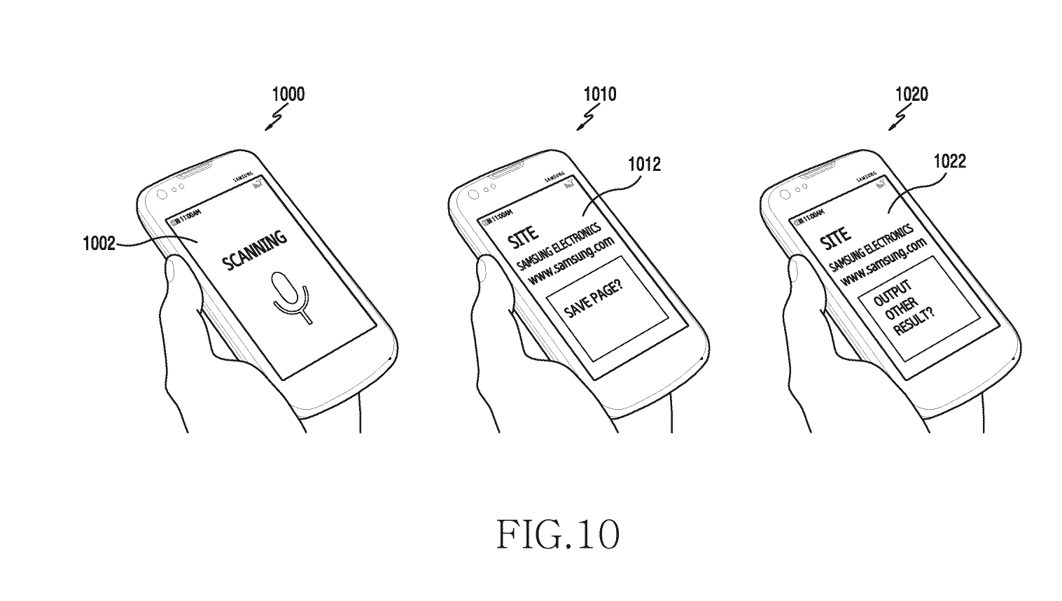

As shown in operation 901, the electronic device 400 may perform a search function. According to various embodiments, the search function may be a function that searches for data stored in the electronic device 400 or data stored in an external device, and derives a search result corresponding to the input of the user. For example, the electronic device 400 may perform a voice recognition application 1002 as illustrated in FIG. 10.

As shown in operation 903, the electronic device 400 may identify whether an input of the user is detected. According to an embodiment, the input of the user may be used as a keyword that is used when the search function is performed. According to an embodiment, the electronic device 400 may detect an audio-type input, a text-type input, etc., to use a detected input as a keyword.

When an input of the user is not detected in operation 903, the electronic device 400 may perform an operation to detect an input of the user. For example, the electronic device 400 may perform an operation corresponding to operation 903.

When an input of the user is detected in operation 903, the electronic device 400 may output retrieved information corresponding to the input, as shown in operation 905. According to various embodiments, the electronic device 400 may derive a search result obtained by using the input of the user as a keyword, and output the derived search result. According to an embodiment, a search range of the electronic device 400 may be a storage space of the electronic device 400 or a storage space of an external device.

As shown in operation 907, the electronic device 400 may operate the camera in a state where retrieved information is displayed. However, various embodiments of the present disclosure are not limited thereto, and the camera may be driven before a search function is performed.

As shown in operation 909, the electronic device 400 may acquire an image of the user through the operated camera. According to an embodiment, the electronic device 400 may operate at least one camera (e.g., a camera disposed in the front side of the electronic device) disposed therein in order to recognize the user's face. According to various embodiments, the electronic device 400 may acquire an image including at least a part of features of the user's face through the camera. According to an embodiment, the electronic device 400 may output a message that notifies of a failure in image acquisition when an image capable of extracting the features is not acquired. Accordingly, the user of the electronic device 400 may move the electronic device 400 in a predetermined direction such that a normal image capable of extracting the features is acquired.

As shown in operation 911, the electronic device 400 may determine an emotion of the user by analyzing the acquired image. According to an embodiment, the emotion of the user may be expressed in response to the output search result, and include a positive emotion and a negative emotion. According to various embodiments, the electronic device 400 may analyze the acquired image so as to extract a feature point associated with at least a part (e.g., eyebrows, eyes, lips, a mouth, etc.) of the body, and determine the emotion of the user based on the extracted feature point. For example, the electronic device 400 may make a determination of a positive emotion when a type of the feature point extracted from the image corresponds to a predetermined type associated with joy, pleasure, and so on. For another example, the electronic device 400 may make a determination of a negative emotion when a type of the feature point extracted from the image corresponds to a predetermined type associated with sadness, anger, rage, and so on.

As shown in operation 913, the electronic device 400 may identify whether an emotion of the user associated with a positive emotion is determined. According to an embodiment, the electronic device 400 may identify whether a determination of a positive emotion has been made as a result of an operation to determine an emotion of the user.

When the emotion of the user associated with a positive emotion is determined in operation 913, the electronic device 400 may perform a corresponding function, as shown in operation 915. According to an embodiment, the electronic device 400 may perform an operation to output a search result corresponding to the input of the user. For example, the electronic device 400 may determine that the user has been satisfied with the output search result based on the positive emotion of the user, and perform an operation associated with operation 905, in response thereto. According to various embodiments, the electronic device 400 may output 1012 feedback information corresponding to a positive emotion in a state where retrieved information has been output, as illustrated in FIG. 10.

When the emotion of the user associated with a negative emotion is determined in operation 913, the electronic device 400 may output feedback information for outputting new retrieved information, as shown in operation 917. For example, the electronic device 400 may output 1022 feedback information corresponding to a negative emotion in a state where retrieved information has been output, as illustrated in FIG. 10. According to an embodiment, the electronic device 400 may determine that the user is not satisfied with the output search result based on the negative emotion of the user, and perform an operation for outputting new retrieved information (or other retrieved information) corresponding to the input of the user, which has been used as a keyword, in response thereto. In addition, the electronic device 400 may omit an operation to output feedback information in response to a determination of a negative emotion of the user. For example, the electronic device 400 may not output feedback information and output new retrieved information.

FIG. 10 is a diagram illustrating a screen configuration of an electronic device 400 that provides a search function according to various embodiments of the present disclosure. According to an embodiment, the electronic device 400 may be the electronic device 101, the electronic device 201, the processor 120, or the control unit 470.

According to various embodiments, the electronic device 400 may perform 1000 an operation to detect an input of the user. According to an embodiment, the electronic device 400 may detect an input of the user in a state 1002 where a search function has been performed. For example, the input of the user may be a voice input and used as a keyword.

According to various embodiments, the electronic device 400 may output retrieved information (e.g., Samsung Electronics web site information) corresponding to the input of the user (e.g., Samsung Electronics).

According to various embodiments, the electronic device 400 may determine an emotion of the user in a state where retrieved information has been output, and output feedback information corresponding to the emotion 1010, 1020. According to an embodiment, the electronic device 400 may output 1012 feedback information (e.g., save retrieved page?) on a positive emotion in response to a determination of a positive emotion of the user for the retrieved information. According to another embodiment, the electronic device 400 may output 1022 feedback information (e.g., output other result?) on a negative emotion in response to a determination of a negative emotion of the user for the retrieved information.

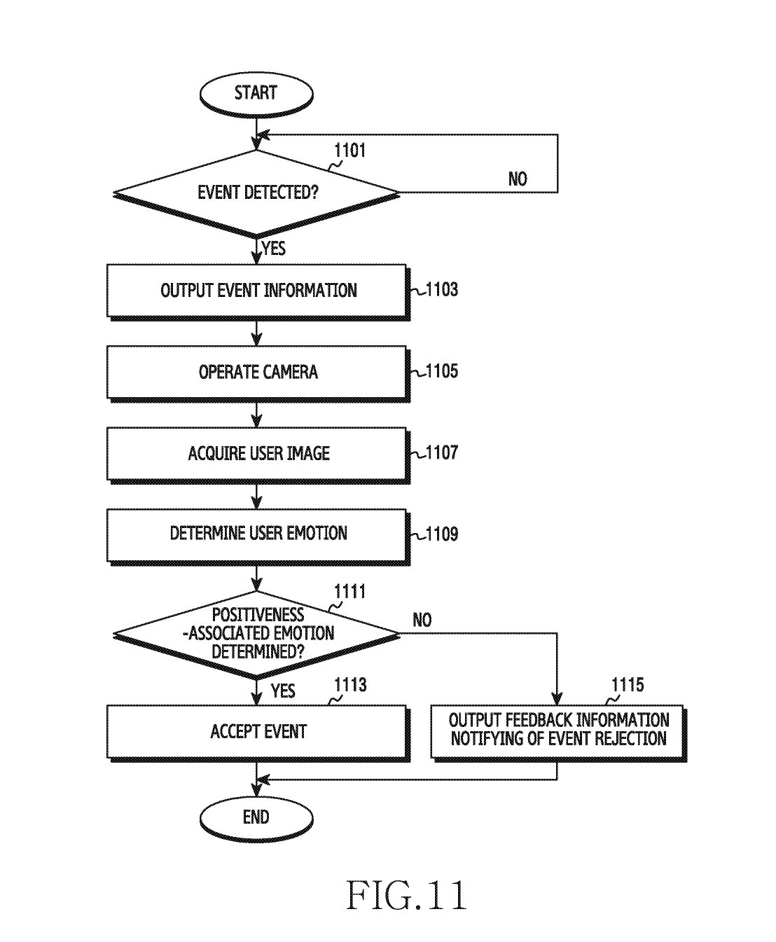

FIG. 11 is a flow diagram illustrating a performance procedure of an event processing method of an electronic device according to various embodiments of the present disclosure. According to an embodiment, the electronic device 400 may be the electronic device 101, the electronic device 201, the processor 120, or the control unit 470.

According to an embodiment, an event may an incoming associated event. For example, the electronic device 400 may detect occurrence of an event such as call reception, message reception, email reception, and so on.

As shown in operation 1101, the electronic device 400 may identify whether occurrence of an event is detected.

If occurrence of an event is not detected in operation 1101, the electronic device 400 may repeatedly perform an operation to detect occurrence of an event.

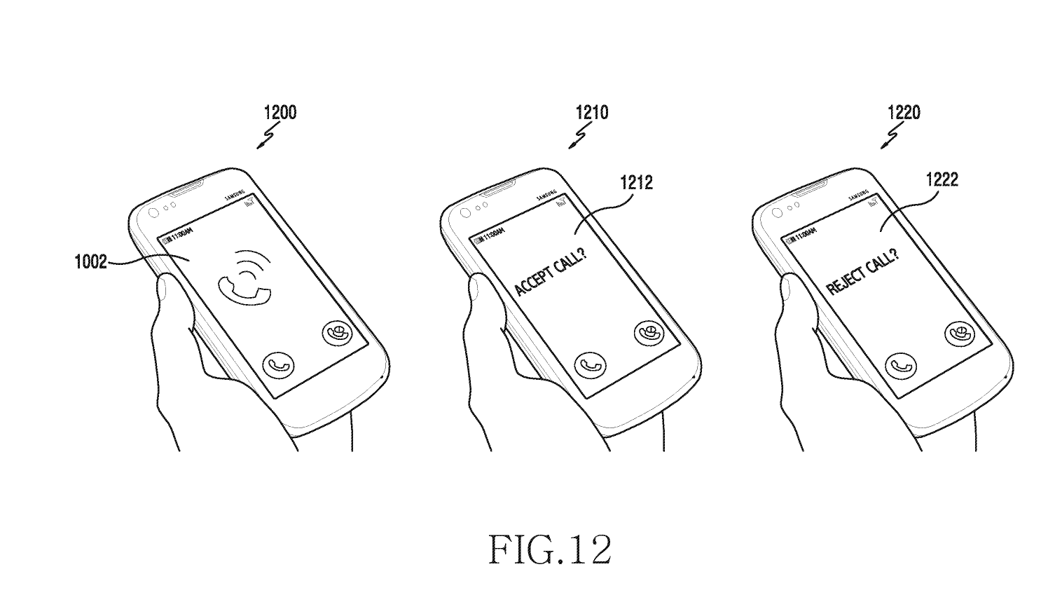

If occurrence of an event is detected in operation 1101, the electronic device 400 may output information on the occurred event, as shown in operation 1103. For example, in response to occurrence of a call reception event, the electronic device 400 may output 1202, along with a caller's information, information by which call reception and call rejection may be selected according thereto, as illustrated in FIG. 12.

As shown in operation 1105, the electronic device 400 may operate the camera in a state where event information has been output. However, various embodiments of the present disclosure are not limited thereto, and the camera may be driven before occurrence of an event is detected.

As shown in operation 1107, the electronic device 400 may acquire an image of the user through the operated camera. According to an embodiment, the electronic device 400 may acquire an image including at least a part of the user's body (e.g., face). For example, at least one of a mouth, lips, eyes, eyebrows, and a nose may be included in the image.

As shown in operation 1109, the electronic device 400 may determine an emotion of the user by analyzing the acquired image. According to an embodiment, the electronic device 400 may determine the emotion of the user based on the feature (e.g., shape, change in movement, skin color, and so on) of a part of the body included in the image. For example, the electronic device 400 may determine whether the user has expressed a positive response or a negative response with respect to the occurred event.

As shown in operation 1111, the electronic device 400 may determine whether an emotion of the user associated with a positive emotion is determined. According to an embodiment, the electronic device 400 may identify whether a positive emotion has been determined as a result of an operation to determine an emotion of the user.

If an emotion of the user associated with a positive emotion is determined in operation 1111, the electronic device 400 may accept the event, as shown in operation 1113. For example, when a positive emotion of the user for an incoming associated event is determined, the electronic device 400 may perform a process to accept the incoming event. For example, the electronic device 400 may automatically accept the incoming event in a state where an input of the user has not been detected. According to an embodiment, the electronic device 400 may accept the event after outputting 1212 feedback information corresponding to a positive emotion in a state where event information has been output, as illustrated in FIG. 12.

If an emotion of the user associated with a negative emotion is determined in operation 1111, the electronic device 400 may output feedback information that notifies of event rejection, as shown in operation 1115. For example, the electronic device 400 may output 1222, as feedback information, a screen on which event rejection may be selected, as illustrated in FIG. 12. In addition, the electronic device 400 may omit an operation to output feedback information in response to a determination of a negative emotion of the user. For example, the electronic device 400 may not output feedback information and reject an event occurring regardless the input of the user.

In the present embodiment, an incoming related event is described. However, according to various embodiments, the electronic device 400 may detect occurrence of a notification (e.g., an alarm notification) associated event.

According to an embodiment, the electronic device 400 may determine an emotion of the user in response to occurrence of an alarm event. For example, the electronic device 400 may stop occurrence of an alarm based on a determination of a situation in which the user may turn off the alarm, in response to a determination of a positive emotion (e.g., a state of having slept well). For another example, the electronic device 400 may increase the frequency of occurrences of an alarm based on a determination of a situation in which the user may not stop the occurrence the alarm, in response to a determination of a negative emotion (e.g., a state of having not slept well).

FIG. 12 is a diagram illustrating a screen configuration of an electronic device that processes an event according to various embodiments of the present disclosure. According to an embodiment, the electronic device 400 may be the electronic device 101, the electronic device 201, the processor 120, or the control unit 470.

According to various embodiments, the electronic device 400 may detect occurrence of an event. For example, the event may be associated with an incoming event.

According to various embodiments, the electronic device 400 may output 1200 event information (e.g., caller information, and information by which call reception and call rejection are selected according thereto) in response to detection of a call reception event.

According to various embodiments, the electronic device 400 may determine an emotion of the user in a state where event information has been output, and output feedback information corresponding to the emotion 1210, 1220. According to an embodiment, the electronic device 400 may output 1212 feedback information (e.g., accept call?) on a positive emotion in response to a determination of a positive emotion of the user for the event information. According to another embodiment, the electronic device 400 may output 1222 feedback information (reject call?) on a negative emotion in response to a determination of a negative emotion of the user for the event information.

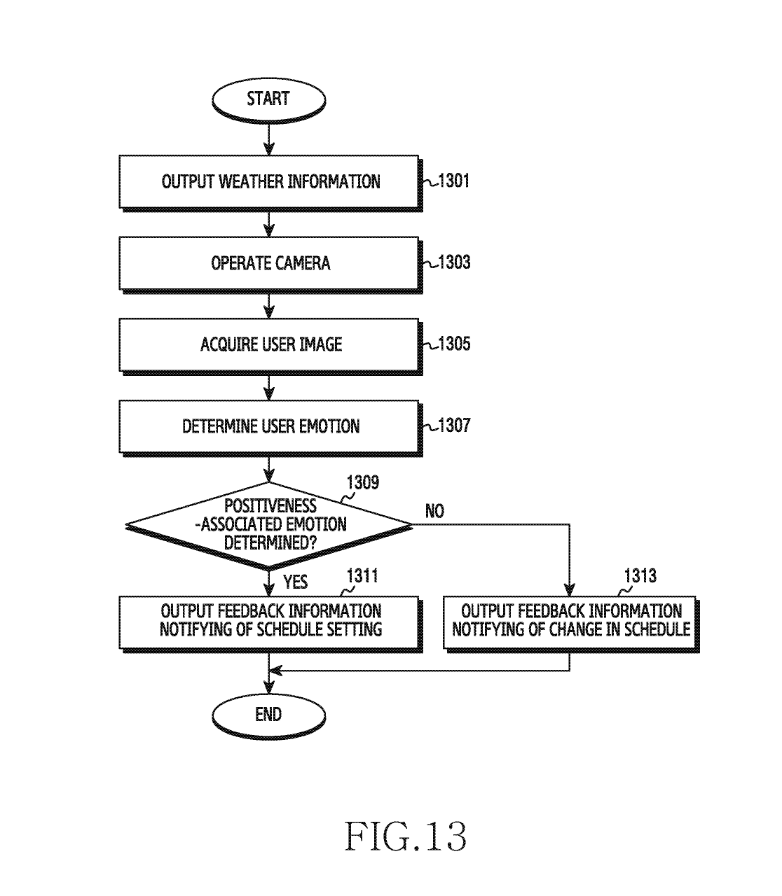

FIG. 13 is a flow diagram illustrating a performance procedure of a schedule management method of an electronic device according to various embodiments of the present disclosure. According to an embodiment, the electronic device 400 may be the electronic device 101, the electronic device 201, the processor 120, or the control unit 470.

As shown in operation 1301, the electronic device 400 may output weather information. According to an embodiment, the electronic device 400 may output execution information on an application that provides weather information.

As shown in operation 1303, the electronic device 400 may operate the camera in a state where weather information has been output. However, various embodiments of the present disclosure are not limited thereto, and the camera may be driven before weather information is output.

As shown in operation 1305, the electronic device 400 may acquire an image of the user through the operated camera. According to an embodiment, the electronic device 400 may acquire an image including at least a part of the user's body (e.g., face). For example, at least one of a mouth, lips, eyes, eyebrows, and a nose may be included in the image.

As shown in operation 1307, the electronic device 400 may determine an emotion of the user by analyzing the acquired image. According to an embodiment, the electronic device 400 may determine an emotion of the user based on the feature (e.g., shape, change in movement, skin color, and so on) of a part of the body included in the image. For example, the electronic device 400 may determine whether the user has expressed a positive response or a negative response with respect to the output weather information.

As shown in operation 1309, the electronic device 400 may identify whether an emotion of the user associated with a positive emotion is determined. According to an embodiment, the electronic device 400 may identify whether a positive emotion has been determined as a result of an operation to determine an emotion of the user.

When an emotion of the user associated with a positive emotion is determined in operation 1309, the electronic device 400 may output feedback information that notifies of schedule setting, as shown in operation 1311. According to an embodiment, when a positive emotion of the user for the output weather information is determined, the electronic device 400 may perform a process such that a schedule is set on a date corresponding to weather for which the user expressed a positive emotion.

When an emotion of the user associated with a negative emotion is determined in operation 1309, the electronic device 400 may output feedback information that notifies of a change in schedule, as shown in operation 1313. For example, the electronic device 400 may perform a process to identify whether a schedule is set on a date corresponding to weather for which the user expressed a negative emotion, and change the schedule on the corresponding date to another date.

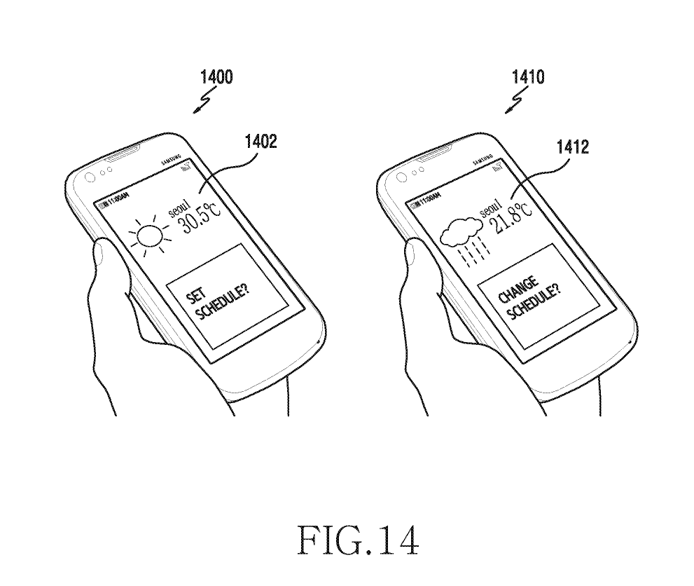

FIG. 14 is a diagram illustrating a screen configuration of an electronic device 400 that provides a schedule management function according to various embodiments of the present disclosure. According to an embodiment, the electronic device 400 may be the electronic device 101, the electronic device 201, the processor 120, or the control unit 470.

According to various embodiments, the electronic device 400 may provide weather information. According to an embodiment, the electronic device 400 may execute an application that provides weather information.

According to various embodiments, the electronic device 400 may determine an emotion of the user in a state where weather information has been output, and output feedback information corresponding to the emotion 1400, 1410. According to an embodiment, the electronic device 400 may output 1402 feedback information (e.g., set a schedule?) on a positive emotion in response to a determination of a positive emotion of the user for weather information. For example, the electronic device 400 may output feedback information such that the user sets a schedule on a date corresponding to weather for which the user expressed a positive emotion. According to another embodiment, the electronic device 400 may output 1412 feedback information (e.g., change a schedule?) on a negative emotion in response to a determination of a negative emotion of the user for weather information. For example, the electronic device 400 may output feedback information to identify a schedule set on a date corresponding to weather for which a negative emotion is expressed, and change the schedule set on the corresponding data to another date.

An operation method of an electronic device according to various embodiments may include operations of performing at least one function for the electronic device, determining an emotion of a user for the performed function, and outputting a scheme for controlling the performed function according to the emotion of the user.

According to various embodiments, an operation that controls the performed function in response to a determination of a positive emotion of the user may be included.

According to various embodiments, an operation that controls a function different from the performed function, in response to a determination of a negative emotion of the user, may be included.

According to various embodiments, an operation that determines the emotion of the user by analyzing an image acquired through the camera module may be included. According to an embodiment, the image may include at least a part of the user's face.

According to various embodiments, an operation that determines the emotion of the user by measuring biometric information of the user through a sensor may be included. According to an embodiment, the biometric information may include at least one of blood pressure, heartbeats, and body temperature.

According to various embodiments, an operation that controls a function of the electronic device based on an emotion of the user additionally determined after the scheme is output may be included.

According to various embodiments, the function may be performed by a voice input.

According to various embodiments, a scheme for controlling the performed function may be output using at least one of audio data and text data.

An electronic device and method according to various embodiments of the present disclosure, for example, may determine an emotion of the user after performing an operation corresponding to an input of the user, and thus determine whether the input of the user has been accurately recognized.

An electronic device and method according to various embodiments of the present disclosure, for example, may control an operation of the electronic device based on an emotion of the user, and thus omit an operation that recognizes additional input of the user.

Also, an electronic device and method according to various embodiments of the present disclosure may provide feedback information based on an emotion of the user for the performed operation, so that the user may determine whether the input has been accurately recognized.

Although the present disclosure has been described with various exemplary embodiments, various changes and modifications may be suggested to one skilled in the art. It is intended that the present disclosure encompass such changes and modifications as fall within the scope of the appended claims.

What is claimed is:

1. An electronic device comprising:
a memory; and
a processor electronically connected to the memory, wherein the processor is configured to perform at least a first function on the electronic device,
determine an emotion of a user for the performed first function, and
output a scheme for performing the first function based on the emotion of the user.

2. The electronic device of claim 1, wherein the processor is configured to perform the first function in response to a determination of a positive emotion of the user.

3. The electronic device of claim 1, wherein the processor is configured to perform a second function different from the first function in response to a determination of a negative emotion of the user.

4. The electronic device of claim 1, wherein the processor is configured to determine the emotion of the user by analyzing an image acquired through a camera module.

5. The electronic device of claim 4, wherein the image includes at least a part of a face of the user.

6. The electronic device of claim 1, wherein the processor is configured to determine the emotion of the user by measuring biometric information of the user received from a sensor.

7. The electronic device of claim 6, wherein the biometric information of the user includes at least one of blood pressure, heartbeat, or body temperature.

8. The electronic device of claim 1, wherein the processor is configured to control the electronic device based on a second emotion of the user determined after the output of the scheme.

9. The electronic device of claim 1, wherein the processor is configured to determine the emotion of the user in response to detection of a voice input of the user, after the first function is performed.

10. The electronic device of claim 1, wherein the processor is configured to output the scheme for performing the first function using at least one of audio data or text data.

11. An operation method of an electronic device, comprising:
performing a first function for the electronic device;
determining an emotion of a user regarding performance of the first function; and
outputting a scheme for performing the first function based on the emotion of the user.

12. The method of claim 11, further comprising performing the first function in response to a determination of a positive emotion of the user.

13. The method of claim 11, further comprising performing a second function different from the first function in response to a determination of a negative emotion of the user.

14. The method of claim 11, further comprising determining the emotion of the user by analyzing an image acquired through a camera module.

15. The method of claim 14, wherein the image includes at least a part of a face of the user.

16. The method of claim 11, wherein the determining the emotion of the user includes measuring biometric information of the user through a sensor.

17. The method of claim 16, wherein the biometric information includes at least one of a user's blood pressure, heartbeat, or body temperature.

18. The method of claim 11, further comprising controlling the electronic device based on a second emotion of the user determined after the output of the scheme.

19. The method of claim 11, wherein the first function is performed by a voice input of the user.

20. The method of claim 11, wherein outputting the scheme for performing the first function includes using at least one of audio data or text data.
